(19) United States
(12) Patent Application Publication
(10) Pub. No.: US 2025/0157196 A1
(43) Pub. Date: May 15, 2025

(54) METHOD FOR AUTOMATICALLY TRAINING A MODEL FOR PREDICTING MULTIMEDIA DATA AND METHOD FOR DETECTING ANOMALIES BASED ON SUCH A MODEL

(71) Applicant: COMMISSARIAT A L’ENERGIE ATOMIQUE ET AUX ENERGIES ALTERNATIVES, PARIS (FR)

(72) Inventors: Yassine NAJI, GIF-SUR-YVETTE (FR); Aleksandr SETKOV, GIF-SUR-YVETTE (FR); Romaric AUDIGIER, GIF-SUR-YVETTE (FR); Angélique LOESCH, GIF-SUR-YVETTE (FR)

(21) Appl. No.: 18/926,106

(22) Filed: Oct. 24, 2024

(30) Foreign Application Priority Data
Nov. 9, 2023 (FR) 2312204

(51) Int. Cl. G06V 10/774; G06T 7/00; G06T 7/215; G06V 10/764; G06V 10/82; G10L 25/57

(52) U.S. Cl. CPC G06V 10/774; G06T 7/0002; G06T 7/215; G06V 10/764; G06V 10/82; G10L 25/57; G06T 2207/10016; G06T 2207/10036; G06T 2207/20084

(57) ABSTRACT

A method for training a model for reconstructing multimedia data represented by at least one modality, the model being composed of a set of a plurality of different predictors for each datum modality, the training method comprising the steps of, for each datum of a training dataset containing no anomalies, for each datum modality: masking at least part of the datum modality, training each predictor of the set associated with the modality to compute a different prediction of the same masked datum, each predictor being specialized in one possible prediction of the masked datum among various credible alternatives, selecting the predictor of the set that provides the closest prediction to a reference datum extracted from the training data, computing a distance between the prediction and the reference datum, computing a first cost function equal to the sum of the distances for all the modalities, updating the parameters of the predictors selected for each modality so as to minimize the first cost function.

### CROSS-REFERENCE TO RELATED APPLICATION

This application claims priority to foreign French patent application No. FR 2312204, filed on Nov. 9, 2023, the disclosure of which is incorporated by reference in its entirety.

### FIELD OF THE INVENTION

The invention relates to the field of machine-learning methods and concerns a new method for training a model for predicting multimedia data and a method for detecting anomalies using such a model for predicting these multimedia data. The data in question are, for example, images, sequences of images, videos, audio sequences, multispectral images or more generally data that may be multidimensional and multimodal.

### BACKGROUND

Detection of anomalies consists in identifying data that are said to be “abnormal” in a given application context. Data are said to be “abnormal” when they are unusual, unpredictable or undesired. More generally, “abnormal” data may be defined as being data that deviate significantly from “normal” data in a given application context.

The abnormal character of a datum depends on the type of data and the intended application and on the context. For example, if the data are images of a component or product leaving an industrial manufacturing line, an anomaly corresponds to a visible defect in the component or product.

In the case where the data are video sequences, an anomaly corresponds, for example, to an unusual behaviour of a pedestrian in a given area.

Anomaly detection is particularly useful in the field of video surveillance, where it may be used to identify a person behaving unusually in a public or private place, in the field of autonomous driving, where it may be used to identify an unexpected obstacle on the road, and in the field of industrial quality control, where it may be used to identify a defect in a manufactured product.

In the field of machine learning, the task consisting in detecting a category of data is carried out by an optimized detector at the end of training or learning supervised by data representative of the categories to be detected.

Machine-learning methods may therefore be used to develop a model for detecting anomalies in multimedia data.

By definition, abnormal data are inherently rare and diverse compared with normal data, which are abundant. However, to avoid detection biases, it is advisable to train a detector on datasets that are balanced between the various categories.

For this reason, supervised machine-learning methods are unsuitable for dealing with the problem of anomaly detection because the task of annotating abnormal data is extremely expensive and requires a vast range of disparate anomalies to be covered depending on the context and the intended application. Moreover, these approaches are inefficient given the natural imbalance of normal data classes versus abnormal data classes.

A general problem that the invention aims to solve therefore is that of developing an unsupervised machine-learning method for detecting anomalies in multimedia data.

One-class classification machine-learning methods are better suited to the problem of anomaly detection because they use only “normal” data as input and aim to predict or reconstruct these data. The trained model is thus based on extraction of relevant features from normal data and is subsequently used to infer the degree of abnormality of new data to be evaluated.

Unsupervised learning approaches to anomaly detection are based on training an artificial intelligence model (for example a deep neural network) to perform a pretext task on normal data only. In other words, the model is not directly trained to detect anomalies but is trained to perform another task, for example reconstructing normal data, with a view to then using the model to indirectly solve the task of anomaly detection. During the inference phase, an anomaly score may be deduced from the inability of the model to perform the task correctly.

In order for the trained model to be able to effectively characterize the normality of the data and to distinguish it from anomalies, the pretext tasks must meet two necessary conditions. They must be correctly performed by the normal data and they must be incorrectly performed in the presence of anomalies. In other words, the chosen pretext tasks must induce a poor generalization of the model to anomalies.

Methods for detecting anomalies through unsupervised learning may be grouped into essentially two categories: reconstruction-based methods and prediction-based methods.

Approaches based on reconstruction aim to train a model to reconstruct, by way of output, the normal training data received as input. One assumption made by these approaches is that the reconstruction model will not be able to correctly generalize the reconstruction to anomalies, i.e. abnormal data will not be well reconstructed.

Unlike methods based on reconstruction, prediction-based approaches teach models to predict missing information, such as masked parts of normal data, in order to better learn their features.

Methods employing a reconstruction-based approach have the drawback of sometimes also correctly reconstructing abnormal data.

Reference [1] describes a reconstruction-based method for detecting anomalies that involves learning the data distribution using a multi-hypothesis autoencoder. Furthermore, the model is criticized by a discriminator, which prevents the generator from producing unlikely predictions. Autoencoders have the drawback of being capable of reconstructing abnormal features because of their extrapolation capabilities. Thus, they induce a non-negligible rate of non-detection since certain anomalies will be detected as corresponding to normal behaviours.

Methods employing a prediction-based approach generally predict anomalies poorly because training is performed only on normal data and the information to be predicted does not exist in the input data. However, these methods adapt less well to normal data because the missing information to predict is not present in the normal data, this potentially leading to prediction difficulties.

Most prediction-based methods for detecting anomalies involve learning a single prediction, this having the drawback of not reflecting the diversity of normality. Indeed, a single prediction often does not allow the diversity of a behaviour referred to as normal to be characterized. For example, consider a simple scenario of a camera observing a vehicle moving over a road and arriving at an intersection with three possibilities: turn right, go straight on or turn left—these three possible future states may all be qualified “normal”. In such a scenario, a model based on a single predictor will not be able to predict the various future states of the path of the vehicle with a single prediction. On the contrary, the prediction generated will correspond to a mean of the three possible “normal” states. If normal data are not correctly predicted by such a model, then it will also not be possible to detect anomalies through comparison.

One solution to this problem is to design a multiple-prediction model, in order to predict all the “normal” states of a datum.

Reference [2] describes a prediction-based method for detecting anomalies that involves training a model to produce a plurality of different predictions from the same masked datum. Learning a plurality of predictions makes it possible to better cover, in the masked input data, the diversity of behaviours that may be said to be normal.

The authors propose to stochastically predict normal video data using a conditional variational autoencoder. The predictions of the method are made stochastically, this meaning that the samples are not necessarily representative of the learned distribution; in addition, the anomaly score in question does not accurately quantify belongingness to the distribution of the normal data.

There is therefore a need for a new method for detecting anomalies that overcomes the drawbacks of reconstruction- or prediction-based approaches.

### SUMMARY OF THE INVENTION

The proposed invention makes it possible to combine the advantages of reconstruction-based methods and prediction-based methods. The invention consists in training a multi-prediction model that does not generalize predictions well in the presence of anomalies, this improving the ability to detect anomalies. Moreover, because a plurality of predictors are used, the proposed model adapts better to normal data than a single-prediction model. The predictions made are deterministic, this ensuring the repeatability of the anomaly scores returned by the system. The predictions are also diversified, this allowing the entire distribution of the normal data to be covered, each predictor specializing in one particular pattern among all the patterns corresponding to a normal feature.

One subject of the invention is a computer-implemented method for training a model for reconstructing multimedia data represented by at least one modality, the model being composed of a set of a plurality of different predictors for each datum modality, the training method comprising the steps of, for each datum of a training dataset containing no anomalies,
for each datum modality:
   masking at least part of the datum modality,
   training each predictor of the set associated with said modality to compute a different prediction of the same masked datum, each predictor being specialized in one possible prediction of the masked datum among various alternatives considered normal in the context of said multimedia data,
   for each predictor, computing a distance between the prediction and a reference datum extracted from the training data,
   selecting the predictor of the set corresponding to the smallest distance,
computing a first cost function equal to the sum, over all the modalities, of the distances corresponding to each selected predictor,
updating the parameters of the predictors selected for each modality so as to minimize the first cost function during training of the predictors.

In one particular embodiment, the method further comprises:
for each datum modality:
   selecting a subset of the set of predictors that have not been optimized in an earlier iteration of the training,
   computing the sum of the distances between the respective predictions provided by the predictors of said subset and the reference datum,
   computing a second cost function equal to the sum of said distances for all the modalities and modifying the first cost function by adding thereto the second cost function weighted by a weighting factor,
   updating the parameters of the predictor that provides the closest prediction to the reference datum and of the predictors of said subset for each modality so as to minimize the modified first cost function.

According to one particular aspect of the invention:
the multimedia data are represented, in a basic modality, by a temporal sequence of successive images,
the step of masking at least part of the basic modality comprises applying a predefined spatial mask to each image of the sequence so as to mask at least one area of the image,
the reference datum corresponds to one successive image in the temporal sequence with respect to the current image delivered as input to the model,
each predictor is trained to predict said successive image from the current image masked by means of said mask.

According to one particular aspect of the invention:
the multimedia data are further represented, in an additional modality, by an optical flow sequence,
the step of masking at least part of the additional modality comprises masking the entirety of the optical flow,
the reference datum is the optical flow,
each predictor is trained to predict the optical flow from the masked current image in the basic modality.

According to one particular aspect of the invention:
the multimedia data are further represented, in an additional modality, by a sequence comprising, for each image, a set of classes of objects detected in the image,
the step of masking at least part of the additional modality comprises masking the entirety of the sequence of classes of objects,
the reference datum is the sequence of classes of objects,
each predictor is trained to predict the sequence of classes of objects from the masked current image in the basic modality.

According to one particular aspect of the invention:
the multimedia data are further represented, in an additional modality, by an audio sequence synchronized with the sequence of images,
the step of masking at least part of the additional modality comprises removing at least part of the audio sequence,
the reference datum is the audio sequence,
each predictor is trained to predict the audio sequence from the masked current image in the basic modality.

According to one particular aspect of the invention:
the multimedia data are represented, in a basic modality, by a set of images,
the step of masking at least part of the basic modality comprises applying a predefined spatial mask to each image so as to mask at least one area of the image,
the reference datum corresponds to the current image provided as input to the model but not masked,
each predictor is trained to predict said current image from the current image masked by means of said mask.

According to one particular aspect of the invention:
the multimedia data are further represented, in a second modality, by a set of multispectral images,
the step of masking at least part of the second modality comprises removing images at at least one given wavelength,
the reference datum is the set of multispectral images,
each predictor is trained to predict one multispectral image from the masked current image in the basic modality.

According to one particular aspect of the invention, the model comprises:
a first projector neural network receiving as input a masked datum and trained to convert the input into a latent representation,
a recurrent neural network trained to produce a succession of states recurrently, the initial state being equal to the latent representation,
a plurality of predictor neural networks each corresponding to one modality, each predictor network receiving as input the masked datum and a state provided by the recurrent network, the number of states generated by the recurrent network being equal to the number of predictors for one modality.

Another subject of the invention is a computer-implemented method for detecting anomalies in a multimedia dataset having at least one modality, the method comprising the steps of:
executing, for said dataset, the machine-learning model trained by means of the training method according to the first subject of the invention, the model receiving as input the data masked by means of masks identical to those used for the training of said model and producing as output a plurality of predictions,
computing the first cost function from the predictions generated by the model,
computing an anomaly score from a distance between the first cost function and a value representative of the first cost function for a dataset containing no anomalies,
comparing the anomaly score with a predetermined detection threshold and deducing therefrom the presence or absence of anomalies in the data.

Other subjects of the invention are a computer program comprising code instructions for implementing the invention and a computer-readable recording medium on which the computer program according to the invention is recorded.

### BRIEF DESCRIPTION OF THE DRAWINGS

Other features and advantages of the present invention will become more clearly apparent on reading the following description with reference to the following appended drawings.

FIG. 1 shows a schematic of a first example of an architecture of a multi-prediction machine-learning model according to one embodiment of the invention,

FIG. 2 shows a flowchart detailing the steps of a method for training an anomaly-detecting model according to one embodiment of the invention,

FIG. 3 shows a schematic of a second example of an architecture of a multi-prediction model capable of being trained by means of the method of FIG. 2,

FIG. 4 illustrates a step of gradient back-propagation with a view to updating the parameters of the model of FIG. 3,

FIG. 5 illustrates how the gradient back-propagation works for a model taking into account three distinct modalities of the input data,

FIG. 6 shows one example of a machine-learning model for implementing the various networks of the example of FIG. 3,

FIG. 7 shows a flowchart detailing the steps of a method for detecting anomalies based on the model trained according to the method of FIG. 2.

### DETAILED DESCRIPTION

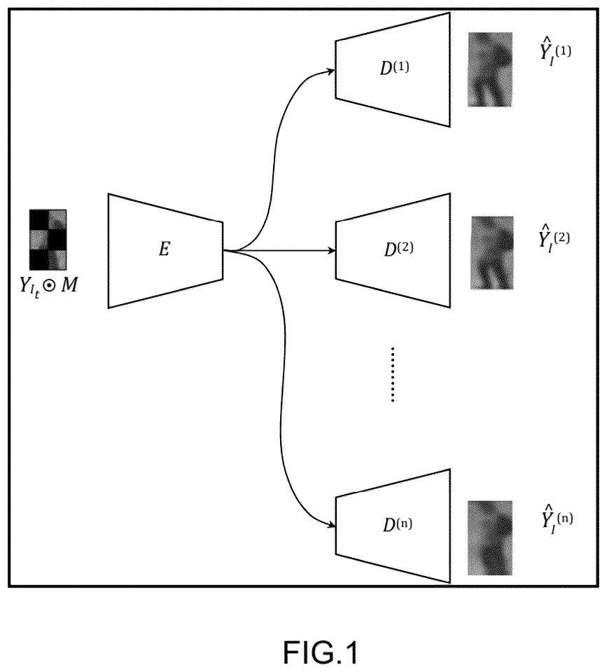

FIG. 1 schematically shows one example of a multi-prediction machine-learning model according to one embodiment of the invention.

The model receives as input data masked with a predefined mask M. It comprises a first encoder network E able to convert the masked input data into a latent representation and a plurality of predictor networks D⁽¹⁾, D⁽²⁾ . . . . D⁽ⁿ⁾ that are trained to each determine one possible prediction of the original datum from the masked datum.

More generally, the n predictions may be generated by n distinct predictor networks or by a single network able to produce n distinct predictions.

The model of FIG. 1 is trained using training data that are said to be “normal”, i.e. training data containing no anomalies in the intended application context. For example, if the intended application consists in detecting defects in parts in the process of being manufactured, the training data contain only images of parts having no defects.

If the intended application is detection of abnormal behaviour in surveillance videos, the training data contain only images of behaviour that is normal in the context of the monitored area.

Thus, the model of FIG. 1 is trained to generate various predictions of the masked portions of the input data, all the predictions being assumed to correspond to normal data. Once the model has been trained, it thus allows anomalies to be detected because, if an anomaly is masked, the model will not reconstruct the anomaly but, in contrast, predict a reconstruction corresponding to a normal behaviour. By comparing the predictions with the actual data, it is therefore possible to detect an anomaly when the predictions deviate from the data.

Use of a plurality of different predictors makes optimal training possible in the sense that the model will not simply learn to generate a prediction corresponding to a mean of all the possible (credible) reconstructions but, in contrast, each predictor will specialize in one possible type of reconstruction.

For example, in the case of an image of a car at a crossroads from which a number of roads may be taken, each predictor will specialize in predicting a path of the car toward one of the roads. In this context, all these predictions correspond to a possible normal behaviour of the car. Conversely, a car driving between two roads (on a pavement or more generally an area not corresponding to a road) corresponds to an abnormal behaviour and therefore to an anomaly in this context.

Generally, the invention applies to any type of multimedia data represented by at least one modality. For example, it applies to video sequences, still images, audio sequences, RGB or multispectral images or a combination of these various media.

Below, the invention is described in the context of data corresponding to video sequences, but it is generalizable to the other types of data mentioned above.

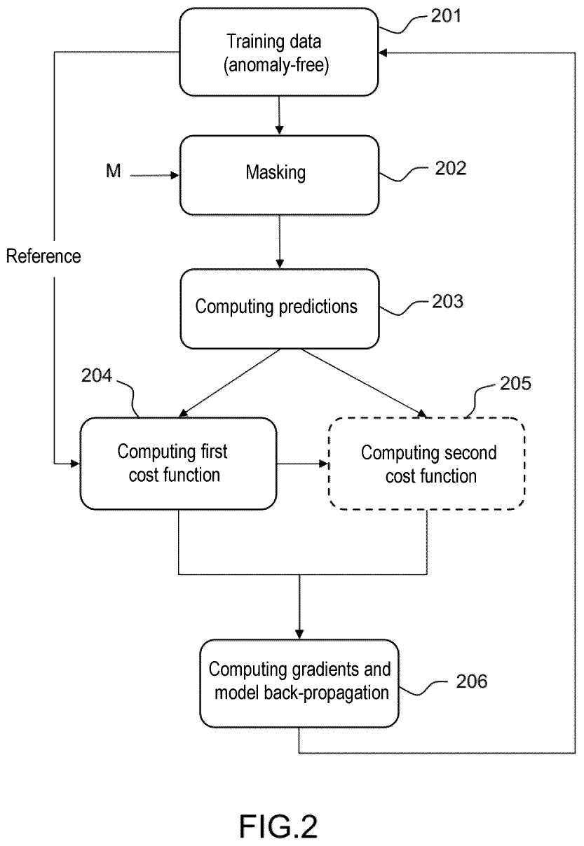

FIG. 2 schematically shows, in a flowchart, the steps of implementation of a method for training the model of FIG. 1 according to one embodiment of the invention.

The training is carried out based on training data 201 which do not contain any anomalies, so as to train the model to reconstruct data that may be said to be “normal” in the sense that they contain no anomalies. Thus, the model is trained to reconstruct partially masked “normal” data.

In step 202, the training data are partially masked by means of a predefined mask M. The masking step 202 may take various forms. It consists in masking or altering at least part of at least one datum modality. More precisely, if the input data are represented by a plurality of modalities, each of the modalities may be completely or partially masked provided that at least one modality is to be masked only partially, in order to provide a minimum of information as input to the model. Examples of different modalities will be described below.

For example, in the case of a sequence of images, the masking step 202 may consist in masking one or more areas of each image using a predefined spatial mask M. The mask may be solely spatial or spatio-temporal in which case it also depends on the temporal index of the image in the sequence. The masking step may consist in completely removing an area of an image or in applying noise, for example white noise, to certain areas of an image.

The masked data are then provided as input to the model to be trained. In step 203, the various predictions of the original datum are computed from the parameters of the model and the masked input datum. In the chosen embodiment, the predictions aim to predict the masked current image or a future image in the video sequence, for example the image following the masked image in the sequence.

The model therefore provides n predictions Ŷ⁽¹⁾, . . . , Ŷ⁽ⁿ⁾ and then, in step 204, a first cost function or loss function L_{NN}(Y) is computed. The chosen cost function consists in selecting, from among the n predictions, the one which is closest to a reference I_{ref} corresponding to the original datum and in computing the error between this selected prediction and the reference. For example, if the model aims to predict an image Iₜ₊₁ at the time t+1 from a masked image Iₜ at the time t, then the reference is the original image Iₜ₊₁. Alternatively, if the model aims to directly predict the current image Iₜ, then the reference is the original image Iₜ.

The first cost function is thus given by the following relationship:

$${L}_{NN} ( Y ) = {min}_{k ∈ [ 1 , n ]} ‖ {\hat{Y}}^{( k )} - {Y}_{ref} ‖ \qquad ( 1 )$$

where Y is a representation of the data in a modality. For example, Ŷ^{(k)} is a prediction of an image Iₜ₊₁ and Y_{ref} is the original image Iₜ₊₁.

The cost function L_{NN}(Y) may be computed for one or more data modalities, as will be illustrated below.

This first cost function aims to encourage prediction diversity via selection, in each iteration, of the prediction closest to the reference.

In step 206, a back-propagation algorithm based on a gradient computation is applied so as to update the parameters of the model to minimize the first cost function. At this stage, only the parameters of the predictor of index k selected to compute the cost function are optimized with the parameters of the encoder E during the back-propagation. Unselected predictors are not optimized. In other words, for each modality, only the predictor closest to the reference datum is optimized.

In one variant of embodiment, a second cost function is computed in step 205 via the following relationship:

$${L}_{NP} ( Y ) = {\sum }_{k ∈ {U}_{T}} ‖ {\hat{Y}}^{( k )} - {Y}_{ref} ‖ \qquad ( 2 )$$

U_{T} is the set of predictors that have not been selected much or at all to compute the first cost function during a preceding iteration of the training. In order to determine the set U_{T}, a selection threshold is for example defined below which a predictor is considered not to have been selected much during an iteration.

More precisely, the training is carried out in a plurality of iterations with, in each iteration, a set of training data being called an epoch. At the end of processing of the previous epoch, predictors that have never been selected to compute the first cost function are noted and the second cost function is computed for these predictors.

It is possible for the predictors selected to compute the second cost function to include the predictor selected to compute the first cost function for a current epoch.

In step 206, the gradient back-propagation algorithm is applied so as to minimize a combination of the two cost functions: L=L_{NN}+λL_{NP} with λ a weighting coefficient. Preferably, the parameter λ is a positive number strictly less than 1, for example equal to 0.1 in order to give more weight to the first cost function L_{NN}. In this way, the predictor the prediction of which is closest to the actual datum is optimized (via the first cost function L_{NN}) while optimizing (via the additional term λ·L_{NP}) predictors that did not participate enough in the training in the preceding epoch. Predictors that have participated enough in the preceding epoch but that are too far from the actual datum are not optimized (specifically, for them the computed gradient is substantially zero with respect to the two cost functions L_{NN} and L_{NP}).

The back-propagation is carried out so as to update the parameters of the predictor selected to compute the first cost function and of the predictors selected to compute the second cost function, and the parameters of the encoder E common to all the predictors.

The objective of optimizing the second cost function L_{NP} is to allow optimization of all the predictors, even those that are never or hardly ever selected, so as to promote prediction diversity.

In one variant of embodiment, the same machine-learning model may be optimized separately to make various predictions relative to various data modalities.

For example, the input data may be organized into the form of a primary modality or basic modality and of one or more additional modalities. In other words, the input data may be represented by a plurality of modalities the importance of which may be varied depending on the application.

The expression “multimodal datum” refers to a set of information that combines a plurality of different data sources or modes. For example, for an audio/video sequence, the sound and the image may be considered to be two modalities of this datum.

For example, for an application for detecting anomalies in visual appearance and movements of objects present in a video, the input datum is a sequence of images that are partially masked. The basic modality here corresponds to the sequence of images. In this scenario, an additional modality is, for example, an optical flow sequence computed on the sequence of images, or a sequence of classes of objects present in each image (detected by means of an object detector applied to the sequence of images). Optical flow is information characterizing the movement of each pixel of an object between two successive images. It allows the movement of objects over time in a video sequence to be characterized. The objects detected in a video sequence may also be classified into object categories. Thus, each image may be accompanied by information about the classes of objects present in that image.

In this example of application, the machine-learning model may also be trained to predict the optical flow based on the masked images received as input, the optical flow being masked entirely, i.e. removed in the sense that it is not provided as input to the model. In this case, a second set of n predictors is optimized using the same cost function and the same learning procedure as the one illustrated in FIG. 2. The only difference is that the predictions are predictions of the optical flow and are compared with the original optical flow by way of reference.

In the same way, replacing the optical flow with a sequence of classes of objects, a third set of n predictors may be optimized.

The use of intermodal prediction tasks, for example predicting the optical flow from a masked image, also allows abnormal correlations that might not be detected if the modalities were processed independently to be detected.

The machine-learning model may thus be optimized overall by means of minimization of a cost function that is a combination of the various cost functions computed for each modality, this combination being, for example, a sum.

Training predictions in various modalities: spatial, temporal, optical flow, etc. makes it possible to better characterize the disparateness of normal data and to differentiate them from abnormal data.

The principle of training the multi-predictors model for multimodal data may be applied to other modalities.

For example, when the intended application is detection of anomalies in a still image, the input of the model is unimodal and corresponds to an image. The predictions provided by the model are predictions of the current image based on the spatially masked image.

In the case where the images are multispectral, the input of the model is multimodal, each modality corresponding to an image at one wavelength or to a wavelength interval. In this scenario, some of the wavelengths are removed and not input to the model, and the predictors are trained to predict the images at the removed wavelengths based on the images at the other wavelengths. For example, the removed wavelengths correspond to the infrared.

In another example of application, the data are multimedia and multimodal, they comprise both a video sequence and an audio sequence. In this scenario, the audio sequence may be removed and not input into the model, and predictors are trained to predict the audio sequence from the video sequence.

Without departing from the scope of the invention, other multimodal data may be considered. A general objective of the invention is to train the model to reconstruct data that are said to be normal from multiple predictions for one or more data modalities.

When the data are multimodal, it is possible to define a basic modality that corresponds to the modality in which the data are provided as input to the model, partially masked, the additional modalities being, for example, completely masked.

One particular example of embodiment of the invention based on video data and a particular learning model will now be described.

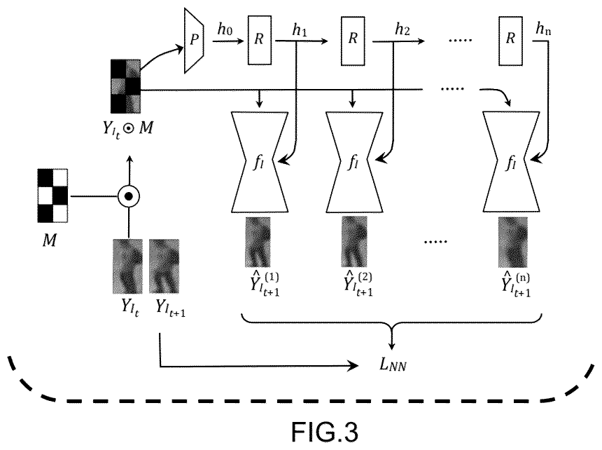

In this example, which is illustrated in FIG. 3, the machine-learning model comprises a first projector network P that receives as input each image Y_{It} of the video sequence masked by a spatial mask M. The projector network P is trained to convert its input into a latent representation in another projection space allowing the information contained in the input to be characterized. In this example, the input data are represented by a single modality, namely the image sequence I.

The model also comprises a network of recurrent neurons R which is trained to produce a succession of states hᵢ recurrently, the initial state h₀ being equal to the latent representation output by the projector network P.

The succession of states hᵢ for i varying from 1 to n makes it possible to characterize the input data using n different representations.

Each output state hᵢ of the recurrent network R is provided, with the masked image, to a predictor network fᵢ so as to provide as output n different predictions of the following image Y_{It+1}.

As will be described below, when a plurality of data modalities are considered, a different predictor network is used for each of the modalities. For example, if m modalities are considered, m predictor networks {f_{T}} therefore generate m*n predictions, i.e. n different predictions for each of the m modalities.

The cost function is computed in the manner described above by comparing the predictions generated by the predictor network with the actual image Y_{It+1} of the sequence.

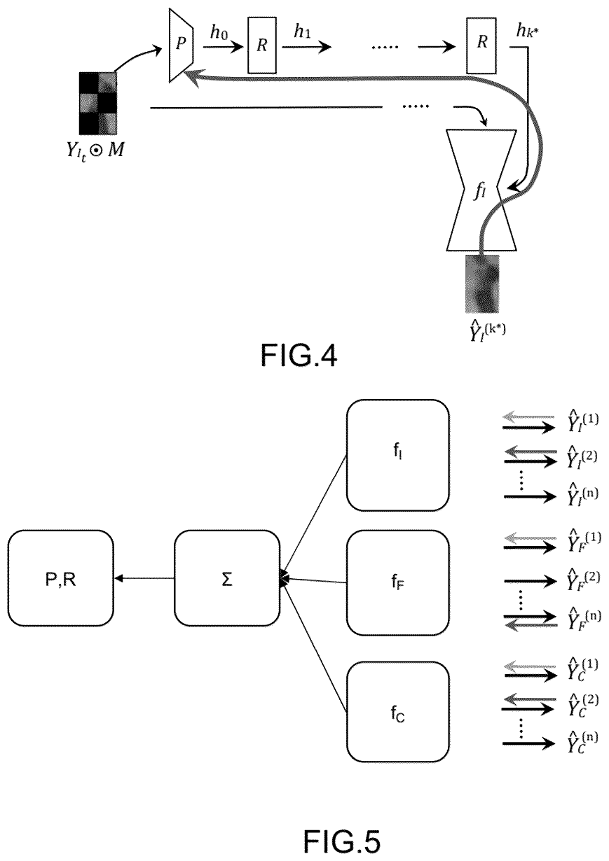

FIG. 4 illustrates one example of the application of the gradient back-propagation algorithm when the prediction Ŷ^{(k*)} is selected as closest to the actual image. The set of parameters of the predictor network fᵢ corresponding to the predictor of rank k* is updated as are the parameters of the recurrent network and of the projector network P.

In one variant of embodiment of the example of FIG. 3, the data are multimodal and the video sequence is accompanied by an optical flow designated Y_{F} and/or by a vector of classes of objects Y_{C} that indicates, for each image, the classes of the objects present in the image.

This variant is shown in FIG. 5, which illustrates, in a schematic, operation of the gradient back-propagation algorithm in the case where three data modalities I (sequence of images), F (sequence of optical flows) and C (sequence of vectors of classes of object) are exploited.

In this variant, the model is trained for the three modalities I, F, C so that n*3 different predictions are obtained by the three predictors corresponding to the three data modalities. Each predictor possesses its own specific set of parameters.

Thus, for each datum modality, the model provides a number n of predictions that may be different for each modality. These n predictions may be generated by n distinct predictor networks or by a single network with n branches.

During the phase of gradient back-propagation, the parameters of each predictor network f_{I}, f_{F}, f_{C} are optimized based on the sum of the respective cost functions computed for each modality, i.e. the sum

$$L = {\sum }_{T = I , C , F} {L}_{NN}^{T} + λ {L}_{NP}^{T}$$

The computed gradients impact the parameters of each predictor network f_{I}, f_{F}, f_{C} according to the respective variations of the cost functions computed for each of the modalities. Thus, the parameters of each predictor network are updated independently.

In the example of FIG. 5, predictor number 2 is used to compute the first cost function for the first modality I, predictor number n is used to compute the first cost function for the second modality F and predictor number 2 is used to compute the first cost function for the third modality C.

Predictor number 1 is used to compute the second cost function for each of the modalities I,F,C.

This example is given purely by way of illustration, it being understood that the predictors used may be different or identical for each of the modalities and each of the cost functions. They are determined independently for each modality according to criteria relative to the computations of the cost functions described above.

The computed gradients are back-propagated through each of the three predictor networks f_{I}, f_{F}, f_{C} to their input layer, then the results are summed via an adder Σ before being propagated to the assembly consisting of the projector network P and of the recurrent network R which for its part is common to all the modalities.

In other words, the entire model is affected by the sum of the three cost functions computed for each modality, but in practice, each respective part of the model (predictors f_{T}, recurrent network R and projector P) is affected differently. The overall cost function is computed as the sum of the cost functions for each modality, itself being a weighted sum of two cost functions L_{NN} and L_{NP}. This induces, in the various predictors f_{T}, back-propagation gradients of different amplitude depending on the role played by the parameters of these predictors in the computation of the predictions. In other words, each predictor network f_{T} is optimized only by the gradient generated by the cost function computed for the corresponding modality. The networks P and R receive in the end the sum of the gradients delivered by the three predictor networks.

One advantage of use of a recurrent network R is that it makes it possible to increase the number of predictors without however increasing the size of the model in terms of number of parameters, this reducing requirements in terms of the computing power of the machine executing the algorithm.

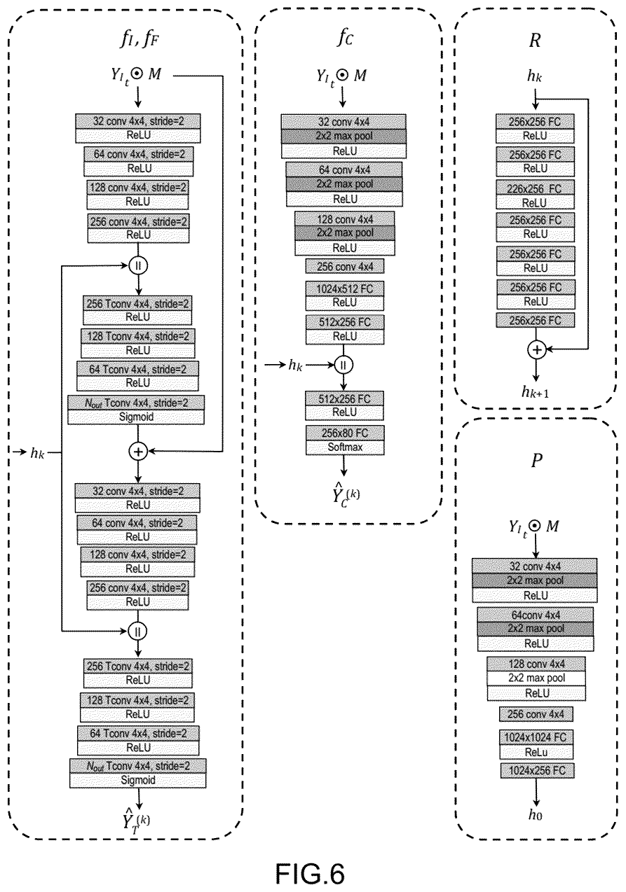

FIG. 6 illustrates one example of a possible architecture for the projector network P, the recurrent network R and the three predictor networks f_{I}, f_{T} and fc corresponding to the basic modality (the sequence of images), and the two secondary modalities (optical flow F and object class C).

In this example, the same predictor network is used for the primary modality and the optical flow and a predictor network of different architecture is used for the object class. This example is non-limiting: it is possible to use the same predictor network for all the modalities with different sets of parameters for each modality or indeed different predictor networks for each modality or even a combination of these two approaches.

In the example of FIG. 6, the projector network P is composed of a series of four convolution layers conv, three max-pooling layers max pool, four activation layers implementing a ReLU activation function and two fully connected convolution layers FC arranged in the order indicated in FIG. 6.

The recurrent network R is composed of 7 fully connected convolution layers (of identical dimensions) FC alternated with an activation layer implementing a ReLU activation function. The input is added to the output via a residual connection.

The predictor network f_{I}, f_{T} is composed of two stacked autoencoders. The two autoencoders are identical and each composed of an encoder with four convolution layers conv and four ReLU activation layers and then a decoder implementing the same layers in reverse order. The last activation layer of the decoder implements a sigmoid activation function.

The input is added to the output of the first autoencoder via a residual connection. The state hₖ provided by the recurrent network is concatenated with the outputs of each encoder.

Thus, the last layer of each decoder may be adapted for each of the two modalities I and F, and in particular the dimension of the convolution layer may vary depending on the modality.

The predictor network fc comprises an encoder consisting of four convolution layers conv, three max-pooling layers max pool, five activation layers implementing a ReLU activation function and two fully connected convolution layers FC arranged in the order indicated in FIG. 6.

The output of the encoder is concatenated with the state hₖ provided by the recurrent network and is provided as input to a decoder composed of two fully connected convolution layers, a ReLU activation layer and an activation layer implementing the Softmax activation function.

The architecture examples given in FIG. 6 are illustrative and non-limiting.

Once the machine-learning model has been trained to reconstruct “normal” data via a plurality of credible predictions, it may be used to detect anomalies in a new dataset that may contain anomalies.

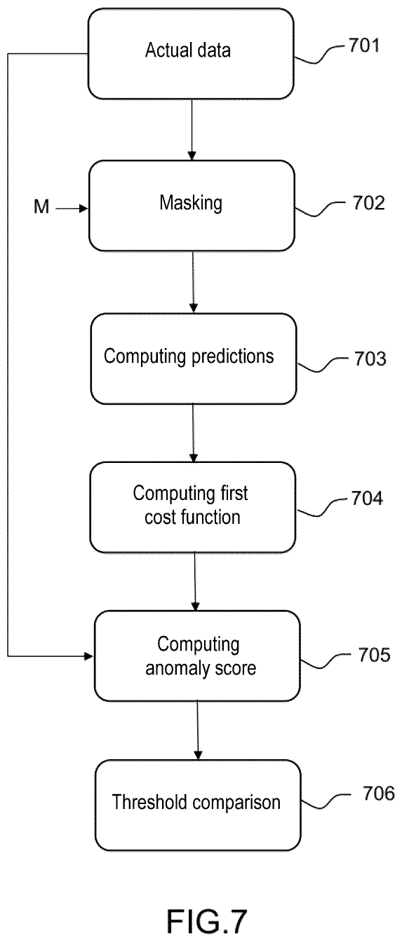

To this end, a method for detecting anomalies involving implementing the model described above is proposed in FIG. 7.

The method is applied to data 701 of the same nature and of the same modalities as those used for the training, except that they may now contain anomalies.

In step 702, the data are masked by means of the same masking procedure as in step 202 of the training, then the masked data are provided as input to the previously trained model.

In step 703, the model computes a plurality of predictions in the same way as in step 203 of the training.

In step 704 only the first cost function L_{NN}(Y) is computed by means of equation (1), the prediction closest to the reference datum being selected. The cost function is computed taking into account one or more modalities of the available data.

Lastly, in step 705, an anomaly score is computed, which score is based on the difference between the cost function L_{NN}(Y) and a value characteristic of the mean of this cost function computed during training. Specifically, if the input data 701 contain no anomalies, the predictors will correctly reconstruct the masked parts of the data and the computed cost function will be close to the mean of this function computed during training. Conversely, if the input data contain an anomaly in the masked areas, the predictors will not reconstruct this anomaly and the cost function computed in step 704 will have a value significantly different from the value computed during training.

One example of an anomaly-score formula is given in relationship (3):

$$S ( Y ) = {\sum }_{T ∈ {T}_{AM}} {w}_{T} \frac{{L}_{NN}^{( T )} ( {Y}_{T} ) - {μ}_{T}}{{σ}_{T}} \qquad ( 3 )$$

T_{AM}={I, F, C} is the set of modalities that the variable T encompasses.
L_{NN}^{(T)}(Y_{T}) is the cost function computed for each modality.
μ_{T} and σ_{T} are the mean and standard deviation of the same cost function as computed during training, for training data containing no anomalies, respectively.
w_{T} is a weighting coefficient that allows different weights to be given to each modality.

The anomaly-score formula may be replaced with any other metric allowing the difference between the cost function computed in step 604 and a value representative of the cost function computed on anomaly-free training data to be computed.

In step 706, the anomaly score is compared with a detection threshold with a view to deducing therefrom the presence or absence of anomalies in the input data.

The invention may be implemented as a computer program comprising instructions for the execution thereof. The computer program may be recorded on a processor-readable recording medium.

Reference to a computer program that, when it is executed, performs any one of the functions described above, is not limited to an application program running on a single host computer. On the contrary, the terms computer program and software are used here in a general sense to refer to any type of computer code (for example application software, firmware, microcode, or any other form of computer instruction) that may be used to program one or more processors to implement aspects of the techniques described here. The computing means or resources may notably be distributed (“Cloud computing”), possibly using peer-to-peer technologies. The software code may be executed on any suitable processor (for example a microprocessor) or processor core or a set of processors, be these provided in a single computing device or distributed among multiple computing devices (for example as possibly accessible in the environment of the device). The executable code of each program allowing the programmable device to implement the processes according to the invention may be stored for example in the hard drive or in read-only memory. Generally speaking, the one or more programs will be able to be loaded into one of the storage means of the device before being executed. The central processing unit is able to command and direct the execution of the instructions or segments of software code of the one or more programs according to the invention, which instructions are stored in the hard drive or in the read-only memory or else in the other abovementioned storage elements.

The invention may be implemented on a computing device based for example on an embedded processor. The processor may be a generic processor, a specific processor, an application-specific integrated circuit (ASIC) or a field-programmable gate array (FPGA). The computing device may use one or more dedicated electronic circuits or a general-purpose circuit. The technique of the invention may be implemented on a reprogrammable computing machine (a processor or a microcontroller for example) executing a program comprising a sequence of instructions, or on a dedicated computing machine (for example a set of logic gates such as an FPGA or an ASIC, or any other hardware module).

The invention makes it possible to improve both reconstruction- and prediction-based learning approaches by using a multi-prediction model trained to reconstruct masked normal data.

Moreover, using a plurality of predictors trained to perform various pretext tasks for various multimodal-data modalities allows the diversity of the “normal” character of the training data to be better captured. Specifically, training predictions in various modalities: spatial, temporal, optical flow, etc. makes it possible to better characterize and discriminate between the various credible contents of normal data.

### REFERENCES

[1] Duc Tam Nguyen, Zhongyu Lou, Michael Klar, Thomas Brox. Anomaly Detection With Multiple-Hypotheses Predictions. In ICML, 2018.
[2] Zhian Liu, Yongwei Nie, Chengjiang Long, Qing Zhang, and Guiqing Li. A hybrid video anomaly detection framework via memory-augmented flow reconstruction and flow-guided frame prediction. In ICCV, 2021.

1. A computer-implemented method for training a model for reconstructing multimedia data represented by at least one modality, the model being composed of a set of a plurality of different predictors for each datum modality, the training method comprising the steps of, for each datum of a training dataset containing no anomalies,
for each datum modality:
masking at least part of the datum modality,
training each predictor of the set associated with said modality to compute a different prediction of the same masked datum, each predictor being specialized in one possible prediction of the masked datum among various alternatives considered normal in the context of said multimedia data,
for each predictor, computing a distance between the prediction and a reference datum extracted from the training data,
selecting the predictor of the set corresponding to the smallest distance,
computing a first cost function equal to the sum, over all the modalities, of the distances corresponding to each selected predictor,
updating the parameters of the predictors selected for each modality so as to minimize the first cost function during training of the predictors.

2. The method for training an anomaly-detecting model according to claim 1, further comprising,
for each datum modality:
selecting a subset of the set of predictors that have not been optimized in an earlier iteration of the training,
computing the sum of the distances between the respective predictions provided by the predictors of said subset and the reference datum,
computing a second cost function equal to the sum of said distances for all the modalities and modifying the first cost function by adding thereto the second cost function weighted by a weighting factor,
updating the parameters of the predictor that provides the closest prediction to the reference datum and of the predictors of said subset for each modality so as to minimize the modified first cost function.

3. The method for training an anomaly-detecting model according to claim 1, wherein:
the multimedia data are represented, in a basic modality, by a temporal sequence of successive images,
the step of masking at least part of the basic modality comprises applying a predefined spatial mask to each image of the sequence so as to mask at least one area of the image,
the reference datum corresponds to one successive image in the temporal sequence with respect to the current image delivered as input to the model,
each predictor is trained to predict said successive image from the current image masked by means of said mask.

4. The method for training an anomaly-detecting model according to claim 3, wherein:
the multimedia data are further represented, in an additional modality, by an optical flow sequence,
the step of masking at least part of the additional modality comprises masking the entirety of the optical flow,
the reference datum is the optical flow,
each predictor is trained to predict the optical flow from the masked current image in the basic modality.

5. The method for training an anomaly-detecting model according to claim 3, wherein:
the multimedia data are further represented, in an additional modality, by a sequence comprising, for each image, a set of classes of objects detected in the image,
the step of masking at least part of the additional modality comprises masking the entirety of the sequence of classes of objects,
the reference datum is the sequence of classes of objects,
each predictor is trained to predict the sequence of classes of objects from the masked current image in the basic modality.

6. The method for training an anomaly-detecting model according to claim 3:
the multimedia data are further represented, in an additional modality, by an audio sequence synchronized with the sequence of images,
the step of masking at least part of the additional modality comprises removing at least part of the audio sequence,
the reference datum is the audio sequence,
each predictor is trained to predict the audio sequence from the masked current image in the basic modality.

7. The method for training an anomaly-detecting model according to claim 1, wherein:
the multimedia data are represented, in a basic modality, by a set of images,
the step of masking at least part of the basic modality comprises applying a predefined spatial mask to each image so as to mask at least one area of the image,
the reference datum corresponds to the current image provided as input to the model but not masked,
each predictor is trained to predict said current image from the current image masked by means of said mask.

8. The method for training an anomaly-detecting model according to claim 7, wherein:
the multimedia data are further represented, in a second modality, by a set of multispectral images,
the step of masking at least part of the second modality comprises removing images at at least one given wavelength,
the reference datum is the set of multispectral images,
each predictor is trained to predict one multispectral image from the masked current image in the basic modality.

9. The method for training an anomaly-detecting model according to claim 1, wherein the model comprises:
a first projector neural network (P) receiving as input a masked datum and trained to convert the input into a latent representation (h₀), a recurrent neural network (R) trained to produce a succession of states (h₁, . . . hₙ) recurrently, the initial state (h₀) being equal to the latent representation,
a plurality of predictor neural networks (f_{T}) each corresponding to one modality, each predictor network receiving as input the masked datum and a state provided by the recurrent network, the number of states generated by the recurrent network being equal to the number of predictors for one modality.

10. A computer-implemented method for detecting anomalies in a multimedia dataset having at least one modality, the method comprising the steps of:
executing, for said dataset, the machine-learning model trained by means of the training method according to claim 1, the model receiving as input the data masked by means of masks identical to those used for the training of said model and producing as output a plurality of predictions, computing the first cost function from the predictions generated by the model,
computing an anomaly score from a distance between the first cost function and a value representative of the first cost function for a dataset containing no anomalies,
comparing the anomaly score with a predetermined detection threshold and deducing therefrom the presence or absence of anomalies in the data.

11. A computer program comprising code instructions for implementing methods according to claim 1 when said program is executed on a computer.

12. A computer-readable recording medium on which the computer program according to claim 11 is recorded.
